(19) United States
(12) Patent Application Publication
(10) Pub. No.: US 2026/0017024 A1
(43) Pub. Date: Jan. 15, 2026

(54) SYSTEMS AND METHODS FOR DETERMINING SOFTWARE MODIFICATIONS USING ADVANCED COMPUTATIONAL MODELS FOR DATA ANALYSIS AND AUTOMATED PROCESSING

(71) Applicant: BANK OF AMERICA CORPORATION, CHARLOTTE, NC (US)

(72) Inventors: Julie C. Tettmar, Matthews, NC (US); Kelly Ann Galligan Davila, Charlotte, NC (US); Paul Martin Mattison, Sherrills Ford, NC (US); Christine Nicole Miller, Charlotte, NC (US)

(73) Assignee: BANK OF AMERICA CORPORATION, CHARLOTTE, NC (US)

(21) Appl. No.: 18/767,155

(22) Filed: Jul. 9, 2024

(51) Int. Cl. G06F 8/30; G06F 8/41; G06F 8/73

(52) U.S. Cl. CPC G06F 8/30; G06F 8/433; G06F 8/73

(57) ABSTRACT

Systems, computer program products, and methods are described herein for determining software modifications using advanced computational models for data analysis and automated processing. The present disclosure is configured to receive a proposed modification, wherein the proposed modification comprises configuring a code segment associated with a software environment; transform the proposed modification into a modification, wherein the modification dynamically configures at least a portion of the code segment; contextualize, using an artificial intelligence (AI) model, the modification, wherein contextualizing the modification comprises understanding the purpose of the modification; determine an impact of the modification upon the code segment; determine compliance of the modification with a compliance regulation; generate supporting documentation associated with the modification; and create a modified code segment, wherein the modified code segment comprises configuring the code segment to adopt the modification.

### TECHNOLOGICAL FIELD

Example embodiments of the present disclosure relate to systems and methods for determining software modifications using advanced computational models for data analysis and automated processing.

### BACKGROUND

There are significant challenges associated with implementing software modifications. Applicant has identified a number of deficiencies and problems associated with ensuring software modifications are configured correctly. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining software modifications using advanced computational models for data analysis and automated processing.

Embodiments of the present invention address the above needs and/or achieve other advantages by providing apparatuses (e.g., a system, computer program product, and/or other devices) and methods for determining software modifications using advanced computational models for data analysis and automated processing. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives a proposed modification, wherein the proposed modification includes configuring a code segment associated with a software environment. In some embodiments, the present invention transforms the proposed modification into a modification, wherein the modification dynamically configures at least a portion of the code segment. In some embodiments, the present invention contextualizes, using an artificial intelligence (AI) model, the modification, wherein contextualizing the modification includes understanding the purpose of the modification. In some embodiments, the present invention determines an impact of the modification, wherein the impact includes understanding how the modification will affect the code segment. In some embodiments, the present invention determines compliance of the modification with a compliance regulation, wherein the compliance regulation includes security requirements and quality requirements associated with the code segment. In some embodiments, the present invention generates supporting documentation associated with the modification, wherein the supporting documentation includes the impact of the modification and the compliance of the modification. In some embodiments, the present invention creates a modified code segment, wherein the modified code segment includes configuring the code segment to adopt the modification.

In some embodiments, contextualizing, using the AI model, the modification further includes analyzing the modified code segment, wherein analyzing the modified code segment includes providing insight into how the modification dynamically configures the code segment. In some embodiments, contextualizing the modification further includes analyzing historical configurations of the modified code segment, wherein the historical configurations include providing insight into how the modified code segment has been configured previously. In some embodiments, contextualizing the modification further includes generating contextualization documentation associated with the modified code segment, wherein the contextualization documentation includes quality assurance records.

In some embodiments, determining the impact of the modification further includes determining a dependency associated with the code segment, wherein the dependency includes a dependence relationship between the code segment and an additional process. In some embodiments, determining the impact of the modification further includes determining a functional impact, wherein the functional impact includes how the modification impacts the code segment's functionality. In some embodiments, determining the impact of the modification further includes determining a resource allocation, wherein the resource allocation includes an allocation of resources needed to execute the modified code segment.

In some embodiments, the present invention generates evidentiary documentation associated with the modified code segment, wherein the evidentiary documentation includes evidence of the modification's dynamic configuration of the code segment. In some embodiments, the present invention audits the modified code segment, wherein auditing the modified code segment includes determining a compliance status via comparing the modified code segment with the compliance regulation.

In some embodiments, the evidentiary documentation further includes causation records which includes explaining why the modification is needed. In some embodiments, the evidentiary documentation further includes intervention records which includes historical actions taken on the code segment prior to the modification.

In some embodiments, determining compliance of the modification with the compliance regulation further includes searching a regulatory database, wherein the regulatory database includes regulations associated with the code segment. In some embodiments, determining compliance of the modification with the compliance regulation further includes determining the modified code segment complies with the compliance regulation.

In some embodiments, determining compliance of the modification with the compliance regulation further includes searching a regulatory database and determining the modified code segment does not comply with the compliance regulation. In some embodiments, determining compliance of the modification further includes generating a second modification, wherein the second modification dynamically configures the modified code segment, and wherein the second modification complies with the compliance regulation.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining software modifications using advanced computational models for data analysis and automated processing, in accordance with an embodiment of the disclosure;

FIG. 2 illustrates a process flow for determining software modifications using advanced computational models for data analysis and automated processing, in accordance with an embodiment of the disclosure; and

FIG. 3 illustrates an exemplary embodiment of implementing software modifications, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” or “model” may refer to core elements of an application, or part of an application that serves as a foundation for a larger piece of software and drives the functionality of the software. In some embodiments, an engine or model may be self-contained, but externally-controllable code that encapsulates powerful logic designed to perform or execute a specific type of function. In one aspect, an engine or model may be underlying source code that establishes file hierarchy, input and output methods, and how a specific part of an application interacts or communicates with other software and/or hardware. The specific components of an engine or model may vary based on the needs of the specific application as part of the larger piece of software. In some embodiments, an engine or model may be configured to retrieve resources created in other applications, which may then be ported into the engine for use during specific operational aspects of the engine or model. An engine or model may be configurable to be implemented within any general purpose computing system. In doing so, the engine or model may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to computing resources, networking resources, memory resources, personnel resources, or the like. Conservation of resources may include lowering the number of resources needed to perform a specific task, process, procedure, or the like. Allocation of resources may include determining a number of resources required to perform a specific task, process, procedure, or like. In this way, the resources allocated to a specific process, for example, may include the computing resources, networking resources, memory resources, personnel resources, and the like that are needed to initiate, maintain, and complete the process.

In modern computing environments, identifying and documenting technical changes, software modifications, and the like prior to deployment into production environments are crucial steps. In many cases, the computing environments are governed by regulatory requirements with which the computing environment needs to comply. These requirements extend to modifications and updates to the computing environment. In other words, any changes to the computing environment also needs to comply with the regulatory requirements. In conventional systems, many challenges are associated with visibility and transparency of such changes, especially considering the compliance requirements of regulatory bodies. Implementing changes and modifications in conventional systems are often met with opaque procedures which do not allow for an understanding of what modifications were made and whether those modifications comply with the regulatory requirements. Therefore, systems and methods for determining software modifications using advanced computational models for data analysis and automated processing are introduced.

The present disclosure provides an artificial intelligence (AI) model that documents technical changes to software and evaluates that the proposed changes comport with software development guidelines, including quality and security requirements. In one embodiment, the invention facilitates automated quality assurance (QA) testing and generates supporting documentation of the QA process. In addition, the AI model creates necessary documentation for evidence of the changes, which are used in audits internally and externally. An additional embodiment may include automated documentation review of the changes, replacing the existing processes of manual screenshots and email communications. Further, the invention may evaluate which compliance regulations apply, review the requirements of the regulations, and evaluate if the proposed technical change complies with the applicable regulations. In an additional embodiment, the AI model may monitor internal systems for compliance and misappropriation assessments.

What is more, the present disclosure provides a technical solution to a technical problem. As described herein, the technical problem includes identifying and documenting technical changes to software prior to deployment into production environments. The technical solution presented herein allows for use of an AI model to determine the technical changes' compliance with regulatory requirements. In particular, the software modification determination system (e.g., the system 130 described herein) is an improvement over existing solutions to the conventional procedures associated with software modification management and implementation, (i) with fewer steps to achieve the solution, thus reducing the amount of computing resources, such as processing resources, storage resources, network resources, and/or the like, that are being used (e.g., using an AI model to document and evaluate proposed modifications), (ii) providing a more accurate solution to problem, thus reducing the number of resources required to remedy any errors made due to a less accurate solution (e.g., automating quality assurance testing and generating supporting documentation associated with the testing process), (iii) removing manual input and waste from the implementation of the solution, thus improving speed and efficiency of the process and conserving computing resources (e.g., creating, via the AI model, necessary documentation evidencing the modifications to the computing environment, replacing the existing process of manually documenting such modifications), (iv) determining an optimal amount of resources that need to be used to implement the solution, thus reducing network traffic and load on existing computing resources (e.g., using the AI model to determine if the proposed modifications comply with applicable regulations which reduces the need for manual intervention of such modifications). Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer platform itself. Specifically, the software modification determination system as described herein is a solution to the problem of understanding details of software modifications prior to deployment in production environments and whether the proposed modifications comply with regulatory requirements. Further, the software modification determination system may be characterized as identifying a specific improvement in computer capabilities and/or network functionalities in response to the software modification determination system's integration to existing devices, software, applications, and/or the like. In this way, the software modification determination system improves the capability of a system to gain visibility into proposed modifications, ensure technical quality of the proposed modifications, testing the modifications in a pre-deployment environment, and satisfy audit policies and procedures. Further, the software modification determination system improves the functionality of networks in response to reducing the resources consumed by the system (e.g., network resources, computing resources, memory resources, and/or the like).

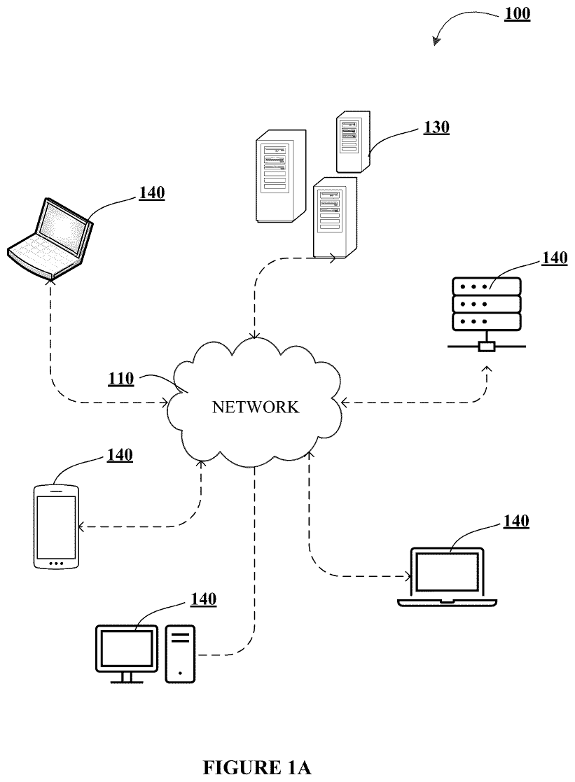

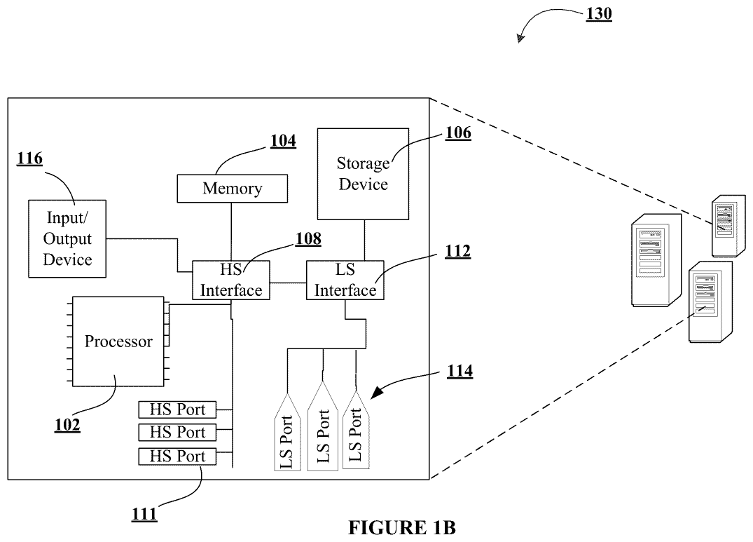

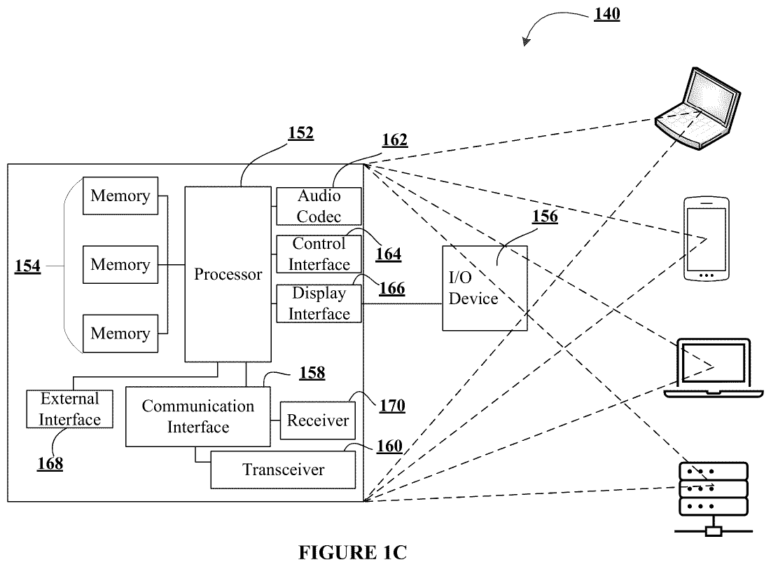

FIGS. 1A-1C illustrate technical components of an exemplary distributed computing environment 100 for determining software modifications using advanced computational models for data analysis and automated processing, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

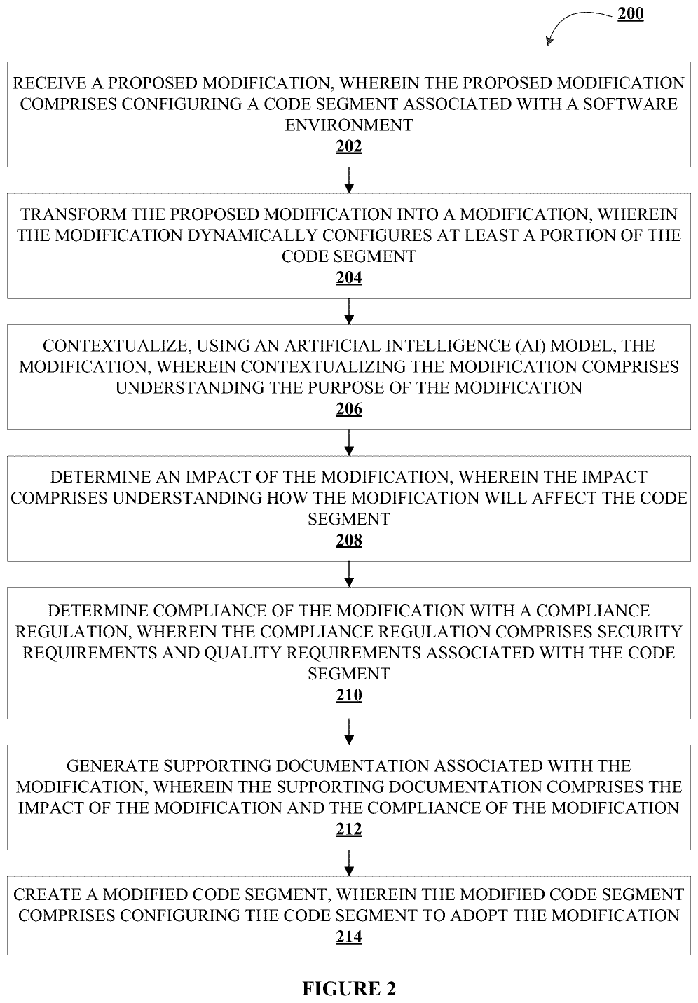

FIG. 2 illustrates a process flow for determining software modifications using advanced computational models for data analysis and automated processing, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a software modification determination system (e.g., similar to one or more of the systems described herein with respect to FIGS. 1A-1C) may perform one or more of the steps of process flow 200. For example, a software modification determination system (e.g., the system 130 described herein with respect to FIGS. 1A-1C) may perform the steps of process flow 200.

As shown in block 202, the process flow 200 of this embodiment includes receiving a proposed modification, wherein the proposed modification includes configuring a code segment associated with a software environment. In some embodiments, the proposed modification may include proposing a new code segment, editing an existing code segment, deletion of a code segment, merging of code segments, splitting a code segment into multiple segments, or the like. The code segment may be any part of a software environment, including the entire software environment. In this way, the code segment may include modifying the entire software environment through additions, modifications, deletions, or the like.

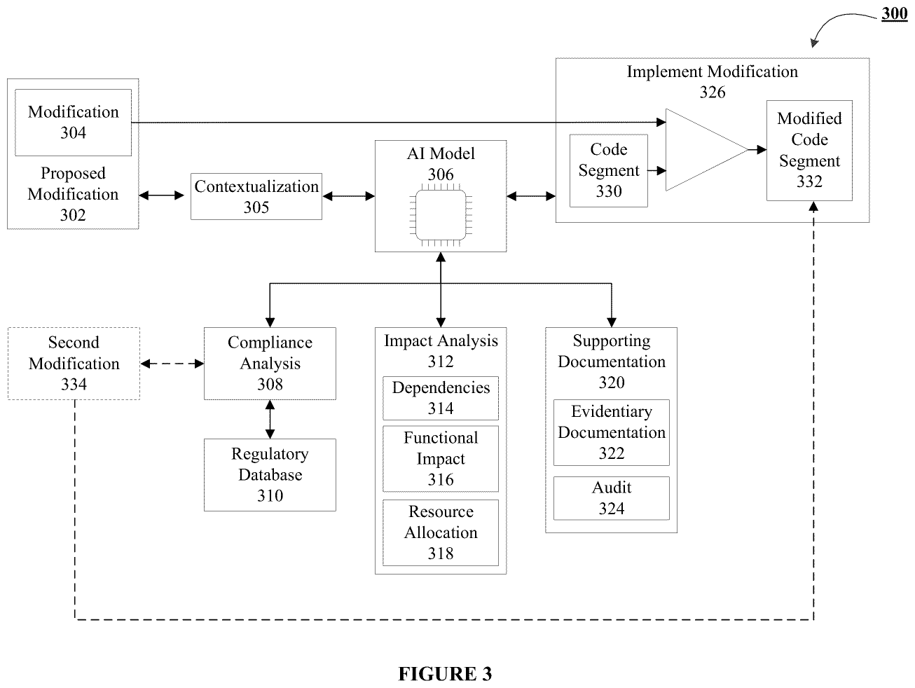

Further, in some embodiments, the proposed modification may include results from correspondence, conceptualization, idea generation, or the like, and may not have any actual code. For example, an individual may propose a modification to a code segment through a conversational dialogue, without actually writing code to modify the code segment. In this way, the proposed modifications may capture modifications that have not yet been written into code. In some embodiments, the proposed modification may include implementation-ready code that may alter a code segment. In this way, the proposed modification may contain code written to modify the code segment. For example, and as shown in FIG. 3, the proposed modification 302 may include the modification 304. The modification 304 may be derived from the proposed modification 302 and may contain all or part of the proposed modification 302.

As shown in block 204, the process flow 200 of this embodiment includes transforming the proposed modification into a modification, wherein the modification dynamically configures at least a portion of the code segment. Transforming the proposed modification into the modification may include retaining some or all of the alterations associated with the proposed modification. For example, if a proposed modification includes adding a new segment of code and editing another segment of code, transforming the proposed modification into a modification may include retaining the addition, the edit, or both the addition and the edit. Further, the transformation of the proposed modification may include taking the proposed modification from a theoretical stage to an implementation-ready modification. For example, the proposed modification may be transformed from an idea to a code script that is ready to be integrated into a code segment, and that alters the code segment.

In some embodiments, the system (e.g., the system 130) may create a modified code segment, wherein the modified code segment includes configuring the code segment to adopt the modification. This may include implementing the modification into the code segment to create a modified code segment. For example, as shown in FIG. 3, the modification 304 and the code segment 330 may be combined to create a modified code segment 332.

As shown in block 206, the process flow 200 of this embodiment includes contextualizing, using an artificial intelligence (AI) model, the modification, wherein contextualizing the modification includes understanding the purpose of the modification. For example, as shown in FIG. 3, the contextualization 305 may include contextualizing the proposed modification 302, the modification 304, or the modified code segment 332. Further, the AI model 306 may perform the contextualization 305 to better understand the modification 304. This may include where in the software environment the modification is best suited, when to implement the modification, and the like.

In some embodiments, contextualizing the modification may include analyzing the modification to provide insight into how the modification dynamically configures the code segment. In this way, the contextualization may involve understanding and incorporating the context in which the modification is made. This may include ensuring the modification is appropriate, effective, and minimally disruptive to the associated environment. In some embodiments, the AI model may analyze, predict, and reduce the impact of the modification. In some embodiments, the AI model may use natural language processing (NLP) to understand comments within the code, associated documentation, messages, and the like to determine the intent behind the modification. Further, the NLP may include analyzing user messages and comments to incorporate the user's goals into the modifications. In some embodiments, the AI model may use machine learning, automated testing and simulations, feedback loops (e.g., continuous monitoring), and the like to further analyze the modification and how it dynamically configures the code segment.

Further, the AI model may analyze historical configurations of the code segment to understand how the code segment has been previously configured. The historical context may include previous modifications and the impact the previous modifications had on the software environment. Further, the AI model may analyze usage patterns which may indicate how the code segment is typically used. The usage patterns may provide guidance to whether the modification may alter the software environment in a way that is conducive to a more efficient software environment and/or code segment. In addition, the usage patterns may provide strategic solutions to resource usage through modification of the code segment. In this way the usage patterns may include where resource usage is most intense. In some embodiments, the AI model may create associated documentation to highlight where resources could be made more efficient.

In addition, the AI model may generate contextualization documentation associated with the modification and/or code segment, which may include quality assurance records, compliance details, and the like. The documentation may include summaries and details associated with the modification's affect upon the code segment and environment as a whole.

As shown in block 208, the process flow 200 of this embodiment includes determining an impact of the modification, wherein the impact includes understanding how the modification will affect the code segment. The modification's impact on the code segment and the environment may indicate the affect the modification has on the code segment, software environment, or the like. In some embodiments, determining the impact of the modification may include determining a dependency associated with the code segment which may include a dependence relationship between the code segment and an additional process. The dependencies may include dependence on other processes, which may include components, modules, functions, services, database, configurations, external systems, and the like. The dependency analysis may include learning how a change (e.g., modification) to a code segment may alter the operations of the software environment and/or other associated processes. Further, technicians of the software environment may have an easier time performing maintenance and debugging procedures knowing the dependencies within the software environment.

Analyzing the dependencies may include using static code analysis, dynamic code analysis, NLP, machine learning modules, and visualization tools to better understand how the software environment is interconnected, and specifically the impact the modification may have on the software environment. The static analysis may include automatically detecting dependencies between classes, functions, and modules in the codebase. The dynamic code analysis may include monitoring the software environment during runtime and capturing data of actual interactions and dependencies. Further, a behavioral analysis may analyze runtime data to understand dynamic dependencies that may not be evident through static analysis. In addition, NLP may be used to review documentation associated with the modification and code segment as well as provide assistance in modification development. The machine learning modules used may predict the modification's impact on dependent processes and further identify anomalies associated with the modification. Further, visualization tools may provide insight in a digestible medium to better understand complex interdependencies and rank dependencies based on importance, quantity, and the like.

In some embodiments, determining the impact of the modification may include determining a functional impact which may include determining how the modification impacts the code segment's functionality. The functional impact may include the modification's affect on the behavior, performance, and reliability of the code segment. In some embodiments, the functional impact may include testing the modification through unit tests, integration tests, regression tests, and the like. These tests may determine the modification's affect on the behavior of the code segment, on the interactions between different processes, and on the existing functionality of the software environment. In some embodiments, if the modification is determined to negatively affect the software environment and/or code segment, additional procedures may include reviewing the modification. The review of the modification may include a developer, technician, user, or the like to review the modification's code to identify potential issues, along with using automated code review tools via the AI model to determine issues. Further, the modification may be analyzed via behavioral tests and user acceptance tests to ensure the modification responds appropriately in various conditions. For example, as shown in FIG. 3, the impact analysis 312 may include the functional impact 316, which may be performed by the AI model 306.

In some embodiments, determining the impact of the modification may include determining a resource allocation which may include the allocation of resources needed to execute the modified code segment. For example, as shown in FIG. 3, the impact analysis 312 may include determining the resource allocation 318. Further, the resource allocation 318 determination may be performed on the proposed modification 302, the modification 304, or the modified code segment 332. In this way, the resources allocated to the code segment may be compared against those allocated for the modified code segment. The AI model may determine the difference in resources required to execute the modified code segment. In some embodiments, the AI model may make suggestions about reducing the number of resources needed to be allocated to the modified code segment. These suggestions may include updating the modification and/or modified code segment to make it less resource intensive.

As shown in block 210, the process flow 200 of this embodiment includes determining compliance of the modification with a compliance regulation, wherein the compliance regulation includes security requirements and quality requirements associated with the code segment. In some embodiments, determining compliance of the modification may include searching a regulatory database, which may include regulations associated with the code segment. In some embodiments, the regulatory database may be associated with the entity that hosts the software modification determination system (e.g., system 130), a third party, a government body, or the like. In this way, the regulatory database may provide guidelines, regulations, mandates, policies, or the like that dictate certain processes and procedures of the software environment. The regulatory database may regulate certain portions of the software environment, such as the code segment, modification, modified code segment, or the like. For example, as shown in FIG. 3, the regulatory database 310 may provide regulations to the AI model 306.

In some embodiments, determining compliance of the modification may include determining the modified code segment complies with the compliance regulation. The compliance analysis performed on the modified code segment may include comparing the modified code segment with the regulatory database. For example, as shown in FIG. 3, the AI model 306 may perform the compliance analysis 308 by using the regulatory database 310. In this way, the compliance analysis may be performed on the proposed modification 302, the modification 304, or the modified code segment 332.

In some embodiments, the software modification determination system may determine the modification does not comply with the compliance regulation. In this way, the system may search a regulatory database and determine the modified code segment does not comply with the compliance regulation. Additionally, or alternatively, the system may generate a second modification, wherein the second modification dynamically configures the modified code segment and complies with the compliance regulation and/or the regulatory database. For example, as shown in FIG. 3, the second modification 334 may stem from the compliance analysis 308. In this way, the compliance analysis 308 may indicate the second modification 334 is needed to bring the modified code segment 332 into compliance based on the regulatory database 310. In some embodiments, the AI model 306 may generate the second modification 334 based on the results of the compliance analysis 308. In some embodiments, the second modification 334 may modify the modified code segment 332 to bring it into compliance with the regulations set out by the regulatory database 310.

As shown in block 212, the process flow 200 of this embodiment includes generating supporting documentation associated with the modification, wherein the supporting documentation includes the impact of the modification and the compliance of the modification. In some embodiments, the software modification determination system (e.g., the system 130 as described herein) may generate evidentiary documentation associated with the modified code segment, wherein the evidentiary documentation includes evidence of the modification's dynamic configuration of the code segment. For example, as shown in FIG. 3, the AI model 306 may generate the supporting documentation 320 which may include the evidentiary documentation 322.

In some embodiments, the evidentiary documentation may include causation records and intervention records. In some embodiments, the causation records may include explanations as to why the modification is needed. The causation records may provide information, comments, notes, strategies, and the like that relate to issues the modification is solving. In this way, the causation records provide the reasons as to why the modification is required and what issues it will solve. The AI model may generate the causation records by using NLP or other similar processes.

In some embodiments, the intervention records may include historical actions taken on the code segment prior to the modification. The historical actions on the code segment may provide insight into what actions have been taken in the past to attempt to resolve issues associated with the code segment. The AI model may use this information to generate suggestions, recommendations, modifications, and the like for the modified code segment to better fit the needs of the system to resolve issues.

In some embodiments, the software modification determination system may audit the modified code segment to determine a compliance status via comparing the modified code segment with the compliance regulation. For example, as shown in FIG. 3, the AI model 306 may perform an audit 324 and generate supporting documentation 320 relating to the audit 324. The audit-related documentation may include findings associated with compliance, impact, performance, contextualization, and the like of the modification and/or modified code segment. The audit report may be shared internally with the entity hosting the software modification determination system or externally with a third part, such as the regulatory body associated with the regulatory database. In this way, the audit reports may provide acceptance testing documentation associated with the modification.

As shown in block 214, the process flow 200 of this embodiment includes creating a modified code segment, wherein the modified code segment includes configuring the code segment to adopt the modification. For example, as shown in FIG. 3, the software modification determination system may implement the modification 326. In some embodiments, the modification implementation 326 may include the modified code segment 332 being created by combining the modification 304 and the code segment 330. Further, in some embodiments, the second modification 334 may dynamically configure the 332 to bring the modified code segment 332 into compliance, based on the compliance analysis 308 and the regulatory database 310. Additionally, or alternatively, the AI model 306 may perform the modification implementation 326 after the completion of the compliance analysis 308, impact analysis 312, and generation of supporting documentation 320.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining software modifications using advanced computational models for data analysis and automated processing, the system comprising:
a processing device;
a non-transitory storage device containing instructions when executed by the processing device, causes the processing device to perform the steps of:
receive a proposed modification, wherein the proposed modification comprises configuring a code segment associated with a software environment;
transform the proposed modification into a modification, wherein the modification dynamically configures at least a portion of the code segment;
contextualize, using an artificial intelligence (AI) model, the modification, wherein contextualizing the modification comprises understanding the purpose of the modification;
determine an impact of the modification, wherein the impact comprises understanding how the modification will affect the code segment;
determine compliance of the modification with a compliance regulation, wherein the compliance regulation comprises security requirements and quality requirements associated with the code segment;
generate supporting documentation associated with the modification, wherein the supporting documentation comprises the impact of the modification and the compliance of the modification; and
create a modified code segment, wherein the modified code segment comprises configuring the code segment to adopt the modification.

2. The system of claim 1, wherein contextualizing, using the AI model, the modification further comprises:
analyzing the modified code segment, wherein analyzing the modified code segment comprises providing insight into how the modification dynamically configures the code segment;
analyzing historical configurations of the modified code segment, wherein the historical configurations comprise providing insight into how the modified code segment has been configured previously; and
generating contextualization documentation associated with the modified code segment, wherein the contextualization documentation comprises quality assurance records.

3. The system of claim 1, wherein determining the impact of the modification further comprises:
determining a dependency associated with the code segment, wherein the dependency comprises a dependence relationship between the code segment and an additional process;
determining a functional impact, wherein the functional impact comprises how the modification impacts the code segment's functionality; and
determining a resource allocation, wherein the resource allocation comprises an allocation of resources needed to execute the modified code segment.

4. The system of claim 1, wherein executing the instructions further causes the processing device to:
generate evidentiary documentation associated with the modified code segment, wherein the evidentiary documentation comprises evidence of the modification's dynamic configuration of the code segment; and
audit the modified code segment, wherein auditing the modified code segment comprises determining a compliance status via comparing the modified code segment with the compliance regulation.

5. The system of claim 4, wherein the evidentiary documentation further comprises:
causation records, wherein the causation records comprise explaining why the modification is needed; and
intervention records, wherein the intervention records comprise historical actions taken on the code segment prior to the modification.

6. The system of claim 1, wherein determining compliance of the modification with the compliance regulation further comprises:
searching a regulatory database, wherein the regulatory database comprises regulations associated with the code segment; and
determining the modified code segment complies with the compliance regulation.

7. The system of claim 1, wherein determining compliance of the modification with the compliance regulation further comprises:
searching a regulatory database, wherein the regulatory database comprises regulations associated with the code segment;
determining the modified code segment does not comply with the compliance regulation; and
generating a second modification, wherein the second modification dynamically configures the modified code segment, and wherein the second modification complies with the compliance regulation.

8. A computer program product for determining software modifications using advanced computational models for data analysis and automated processing, the computer program product comprising a non-transitory computer-readable medium comprising code causing an apparatus to:
receive a proposed modification, wherein the proposed modification comprises configuring a code segment associated with a software environment;
transform the proposed modification into a modification, wherein the modification dynamically configures at least a portion of the code segment;
contextualize, using an artificial intelligence (AI) model, the modification, wherein contextualizing the modification comprises understanding the purpose of the modification;
determine an impact of the modification, wherein the impact comprises understanding how the modification will affect the code segment;
determine compliance of the modification with a compliance regulation, wherein the compliance regulation comprises security requirements and quality requirements associated with the code segment;
generate supporting documentation associated with the modification, wherein the supporting documentation comprises the impact of the modification and the compliance of the modification; and
create a modified code segment, wherein the modified code segment comprises configuring the code segment to adopt the modification.

9. The computer program product of claim 8, wherein contextualizing, using the AI model, the modification further comprises:
analyzing the modified code segment, wherein analyzing the modified code segment comprises providing insight into how the modification dynamically configures the code segment;
analyzing historical configurations of the modified code segment, wherein the historical configurations comprise providing insight into how the modified code segment has been configured previously; and
generating contextualization documentation associated with the modified code segment, wherein the contextualization documentation comprises quality assurance records.

10. The computer program product of claim 8, wherein determining the impact of the modification further comprises:
determining a dependency associated with the code segment, wherein the dependency comprises a dependence relationship between the code segment and an additional process;
determining a functional impact, wherein the functional impact comprises how the modification impacts the code segment's functionality; and
determining a resource allocation, wherein the resource allocation comprises an allocation of resources needed to execute the modified code segment.

11. The computer program product of claim 8, wherein the code further causes the apparatus to:
generate evidentiary documentation associated with the modified code segment, wherein the evidentiary documentation comprises evidence of the modification's dynamic configuration of the code segment; and
audit the modified code segment, wherein auditing the modified code segment comprises determining a compliance status via comparing the modified code segment with the compliance regulation.

12. The computer program product of claim 11, wherein the evidentiary documentation further comprises:
causation records, wherein the causation records comprise explaining why the modification is needed; and
intervention records, wherein the intervention records comprise historical actions taken on the code segment prior to the modification.

13. The computer program product of claim 8, wherein determining compliance of the modification with the compliance regulation further comprises:
searching a regulatory database, wherein the regulatory database comprises regulations associated with the code segment; and
determining the modified code segment complies with the compliance regulation.

14. The computer program product of claim 8, wherein determining compliance of the modification with the compliance regulation further comprises:
searching a regulatory database, wherein the regulatory database comprises regulations associated with the code segment;
determining the modified code segment does not comply with the compliance regulation; and
generating a second modification, wherein the second modification dynamically configures the modified code segment, and wherein the second modification complies with the compliance regulation.

15. A method for determining software modification using advanced computational models for data analysis and automated processing, the method comprising:
receiving a proposed modification, wherein the proposed modification comprises configuring a code segment associated with a software environment;
transforming the proposed modification into a modification, wherein the modification dynamically configures at least a portion of the code segment;
contextualizing, using an artificial intelligence (AI) model, the modification, wherein contextualizing the modification comprises understanding the purpose of the modification;
determining an impact of the modification, wherein the impact comprises understanding how the modification will affect the code segment;
determining compliance of the modification with a compliance regulation, wherein the compliance regulation comprises security requirements and quality requirements associated with the code segment;
generating supporting documentation associated with the modification, wherein the supporting documentation comprises the impact of the modification and the compliance of the modification; and
creating a modified code segment, wherein the modified code segment comprises configuring the code segment to adopt the modification.

16. The method of claim 15, wherein contextualizing, using the AI model, the modification further comprises:
analyzing the modified code segment, wherein analyzing the modified code segment comprises providing insight into how the modification dynamically configures the code segment;
analyzing historical configurations of the modified code segment, wherein the historical configurations comprise providing insight into how the modified code segment has been configured previously; and
generating contextualization documentation associated with the modified code segment, wherein the contextualization documentation comprises quality assurance records.

17. The method of claim 15, wherein determining the impact of the modification further comprises:
determining a dependency associated with the code segment, wherein the dependency comprises a dependence relationship between the code segment and an additional process;
determining a functional impact, wherein the functional impact comprises how the modification impacts the code segment's functionality; and
determining a resource allocation, wherein the resource allocation comprises an allocation of resources needed to execute the modified code segment.

18. The method of claim 15, wherein the method further comprises:
generating evidentiary documentation associated with the modified code segment, wherein the evidentiary documentation comprises evidence of the modification's dynamic configuration of the code segment; and
auditing the modified code segment, wherein auditing the modified code segment comprises determining a compliance status via comparing the modified code segment with the compliance regulation. ensuring the modified code segment complies with the compliance regulation.

19. The method of claim 18, wherein the evidentiary documentation further comprises:
causation records, wherein the causation records comprise explaining why the modification is needed; and
intervention records, wherein the intervention records comprise historical actions taken on the code segment prior to the modification.

20. The method of claim 15, wherein determining compliance of the modification with the compliance regulation further comprises:
searching a regulatory database, wherein the regulatory database comprises regulations associated with the code segment; and
determining the modified code segment complies with the compliance regulation.
